(19) United States
(12) Patent Application Publication
(10) Pub. No.: US 2016/0071129 A1
(43) Pub. Date: Mar. 10, 2016

(54) INFORMATION PROCESSING DEVICE, INFORMATION PROCESSING METHOD, INFORMATION PROCESSING SYSTEM, INFORMATION PROVISION DEVICE, AND PROGRAMS THEREOF

(71) Applicant: SHARP KABUSHIKI KAISHA, Osaka (JP)

(72) Inventors: Kazuto OHHARA, Osaka-shi (JP); Hiroyuki YAMAMURA, Osaka-shi (JP); Toshiroh MUKAI, Osaka-shi (JP); Ikuo KESHI, Osaka-shi (JP)

(73) Assignee: SHARP KABUSHIKI KAISHA, Osaka-shi, Osaka (JP)

(21) Appl. No.: 14/786,066

(22) PCT Filed: Apr. 22, 2014
(86) PCT No.: PCT/JP2014/061230

§ 371 Date: Oct. 21, 2015

(30) Foreign Application Priority Data
Apr. 26, 2013 (JP) 2013-094059

(51) Int. Cl. G06Q 30/02

(52) U.S. Cl. CPC G06Q 30/0203; G06Q 30/0251

(57) ABSTRACT

There are provided an operation history obtaining unit that obtains an operation history of an electronic device installable in a home, and a classification unit that classifies a life pattern of a user operating the electronic device on the basis of the operation history obtained by the operation history obtaining unit.

### TECHNICAL FIELD

The present invention relates to an information processing device, an information processing method, an information processing system, an information provision device, and programs thereof.

The present application is based on and claims priority from Japanese Patent Application No. 2013-094059 filed Apr. 26, 2013, the entire contents of which are incorporated herein by reference.

### BACKGROUND ART

Currently, a technique (in which information about a user is obtained, an item or the like that is expected to be of interest to the user is deduced by analyzing the information, and the item is suggested to the user) is being studied and commercially utilized.

An information recommendation system (that relates to the technique) is known in which a plurality of cluster segmentation results (obtained by segmenting a set of users into a plurality of clusters, using a plurality of user classification methods are combined to thereby recommend an item to a user (see PTL 1). In this system, the distances between vectors that represent preferences of users are measured by using a plurality of user similarity metrics, the set of users is segmented into a plurality of clusters on the basis of the distances between vectors measured by using the user similarity metrics, a plurality of cluster segmentation results are combined, and preferences of the users are extracted.

Further, an information provision system is known that analyzes preferences of a user on the basis of information or the like about places of daily activities based on an operation history of a communication device or GPS (Global Positioning System) information (see PTL 2). The operation history referred to by this system includes a browsing history or a search history related to Web sites and a viewing history related to moving images, and the system analyzes preferences of a user on the basis of these histories and the like.

### CITATION LIST

### Patent Literature

PTL 1: Japanese Unexamined Patent Application Publication No. 2013-29872

PTL 2: Japanese Unexamined Patent Application Publication No. 2012-208661

### SUMMARY OF INVENTION

### Technical Problem

In the techniques described in the above patent literature, preferences of a user are directly analyzed or inferred on the basis of various types of information, and therefore, information that can be suggested to a user is stereotypical, and it might not be possible to make a valuable suggestion to a user.

The present invention has been made in view of the above-described situation, and an object thereof is to generate information for making a valuable suggestion to a user.

### Solution to Problem

An aspect of the present invention provides an information processing device including: an operation history obtaining unit that obtains an operation history of an electronic device installable in a home; and a classification unit that classifies a life pattern of a user operating the electronic device on the basis of the operation history obtained by the operation history obtaining unit.

### Advantageous Effects of Invention

According to the aspect of the present invention, it is possible to generate information for making a valuable suggestion to a user.

### BRIEF DESCRIPTION OF THE DRAWINGS

FIG. 1 is a diagram illustrating an example of a configuration of an information processing system including an information processing device 100 according to a first embodiment of the present invention.

FIG. 2 is a diagram illustrating an example of information retained by a database management system 200 as operation/activation history information 210.

FIG. 3 is a diagram schematically illustrating a series of events to register an association between a user ID and an electronic device in the database management system 200.

FIG. 4 is a diagram schematically illustrating the content of a television viewing history in the operation/activation history information 210 managed by the database management system 200.

FIG. 5 is a diagram illustrating an example of a hardware configuration of the information processing device 100.

FIG. 6 is a diagram illustrating an example of the content of feature vectors generated by a classification processing unit 150.

FIG. 7 is a diagram illustrating an example of patterned information about preferences of users.

FIG. 8 is a diagram illustrating an example of information obtained by summarizing information about preferences of users having similar life patterns for each group.

FIG. 9 illustrates an example of a sequence chart illustrating a flow of a process performed by the information processing system according to the embodiment.

FIG. 10 is a diagram illustrating an example of a functional configuration of an information processing device 100 according to a fourth embodiment.

FIG. 11 is a diagram schematically illustrating a state where the classification processing unit 150 performs a plurality of clustering processes on the basis of a television viewing history.

### DESCRIPTION OF EMBODIMENTS

Embodiments of an information processing device, an information processing method, an information processing system, an information provision device, and programs thereof in the present invention will be described below with reference to the drawings.

### First Embodiment

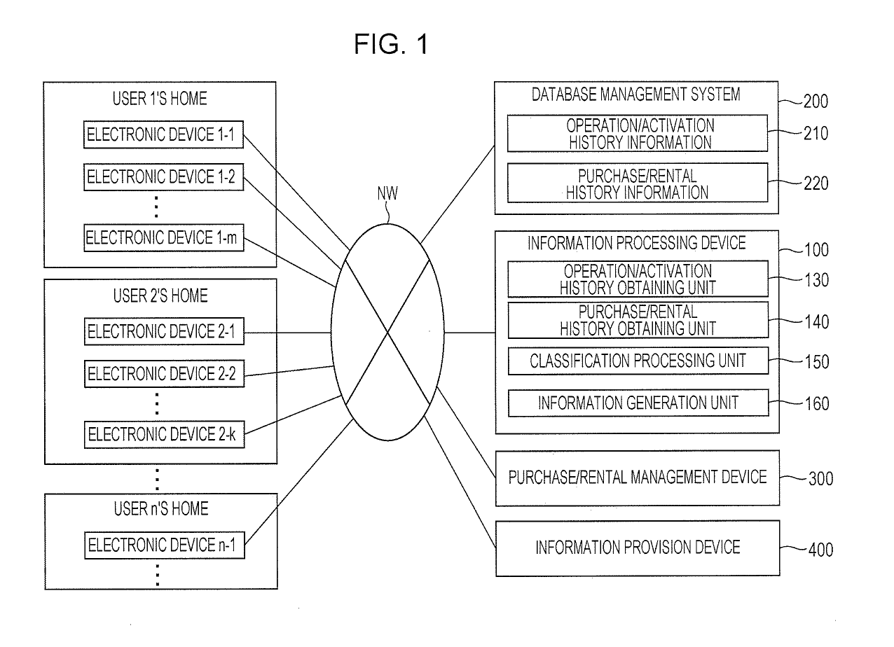

FIG. 1 is a diagram illustrating an example of a configuration of an information processing system including an information processing device 100 according to a first embodiment of the present invention. In the information processing system according to this embodiment, electronic devices 1-1, 1-2, . . . , and 1-m that can be installed in a user 1's home, electronic devices 2-1, 2-2, . . . , and 2-k that can be installed in a user 2's home, and electronic devices n-1, . . . that can be installed in a user n's home (each of n, m, and k is any integer and can be larger than 1) are connected to a network NW. To the network NW, the information processing device 100, a database management system 200, a sales/rental management device 300, and an information provision device 400 are connected.

The network NW is a WAN (Wide Area Network), a LAN (Local Area Network), a PSTN (Public Switched Telephone Network), a VPN (Virtual Private Network), a private communication circuit network, a mobile telephone network, a PHS (Personal Handy-phone System) network, or an information communication network configured by combining these networks, for example.

Examples of electronic devices that are located in users' homes include television receivers, air conditioners, washing machines, refrigerators, vacuum cleaners, microwave ovens, and other home electrical appliances, and may or may not include personal computers, mobile phones, and other information terminals. Each electronic device transmits, to the database management system 200 over the network NW, an operation history and an activation history of operations and activation performed by a user on the electronic device. The database management system 200 is a relational database management system (RDBMS) or a non-relational database management system (NoSQL: Not only SQL). The database management system 200 retains operation/activation history information 210 and purchase/rental history information 220 in a storage device, such as an HDD (Hard Disk Drive) or an SSD (Solid State Drive).

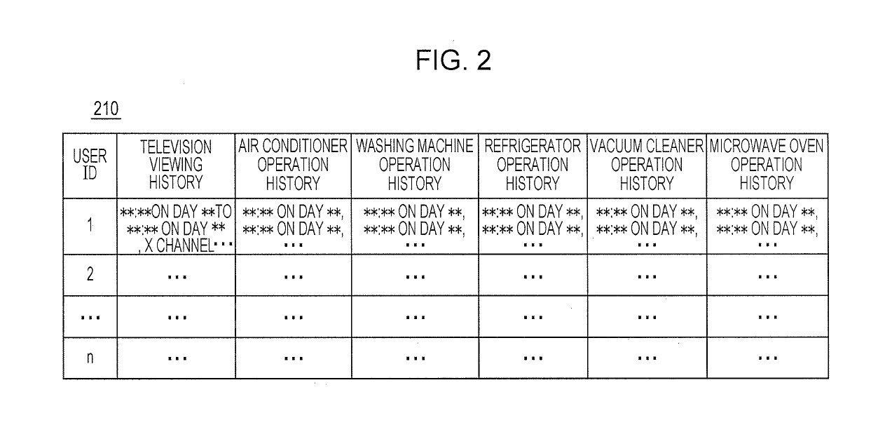

The database management system 200 retains, as the operation/activation history information 210, the operation history and the activation history received from each electronic device in association with identification information (hereinafter “user ID”) of the user. Users are respectively associated with different user IDs. FIG. 2 is a diagram illustrating an example of information retained by the database management system 200 as the operation/activation history information 210. For example, a television viewing history of a user having user ID 1 indicates viewing (or recording) on X channel during a time period from **:** on day ** to **:** on day **. In the operation/activation history information 210, a television viewing history (described below) received from a television receiver and operation histories received from electronic devices are stored for each user (for each user ID). The operation history may include a history of on/off operations performed on each electronic device, a history of temperature control operations performed on an air conditioner, a history of the measured amount of clothing and time settings related to a washing machine, a history of temperature control operations and open/close operations on a refrigerator, an activation history of a vacuum cleaner, a history of activation times of a microwave oven, and so on.

A user ID and an electronic device are associated with each other in such a manner that, upon purchasing the electronic device, some sort of identification information of the user is registered in the database management system 200 together with identification information (hereinafter “electronic device ID”) specific to the electronic device. An electronic device of another user is associated with a different user ID. Note that electronic devices of the same user are not necessarily associated with the same user ID. A sales/rental company that is allied with the information processing system of this embodiment provides a rewards card, a membership card, or the like to the user, and registers identification information (a card ID, a member number, or the like) of the rewards card, membership card, or the like in the database management system 200. The database management system 200 sets any user ID that is associated with the registered identification information. The database management system 200 may use the registered card ID or member number as is as a user ID. That is, the card ID or card number can be used as a user ID in the database management system 200.

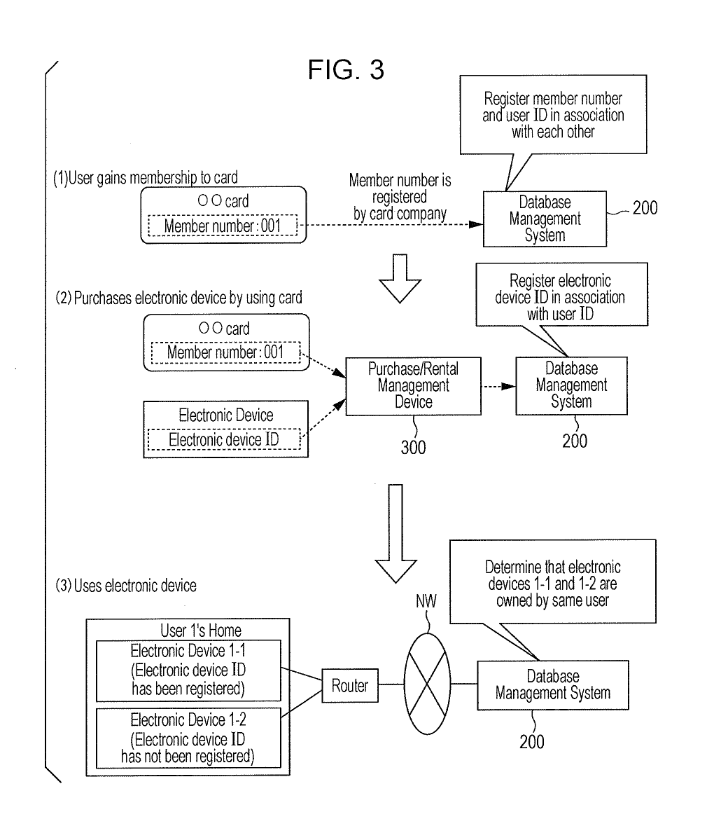

FIG. 3 is a diagram schematically illustrating a series of events to register an association between a user ID and an electronic device in the database management system 200. When a user gains membership to a card, such as a rewards card or a membership card, identification information such as a member number is registered in the database management system ((1) in FIG. 3). To “gain membership to a card” corresponds to a case where a user is granted a right to receive an information provision service provided by the information provision device 100, for example. Thereafter, when the user purchases an electronic device by using the rewards card, membership card, or the like, information for associating identification information of the card with the electronic device ID is transmitted from the purchase/rental management device 300 installed in the store where the purchase has been made to the database management system 200 ((2) in FIG. 3). The purchase/rental management device 300 is a terminal device installed in a store, such as a sales store or a video rental shop, for example, and may include a management server that is connected to the terminal device over the network NW, a sales server for performing mail-order sales over the network NW, or the like. The database management system 200 adds a user ID that corresponds to the received identification information and the electronic device ID to label information in the operation/activation history information 210 in association with each other.

In a case where, for a user, one electronic device has been registered in the database management system 200 in association with the user 1D of the user, other electronic devices used by the same user can be associated with the user ID of the user in the database management system 200 because an IP address of a router or the like for connection to the network NW is common to the electronic devices, for example ((3) in FIG. 3). The series of events is merely an example, and a user may access the database management system 200 or the information processing device 100 by using a personal computer and manually input the electronic device ID of an electronic device owned by the user.

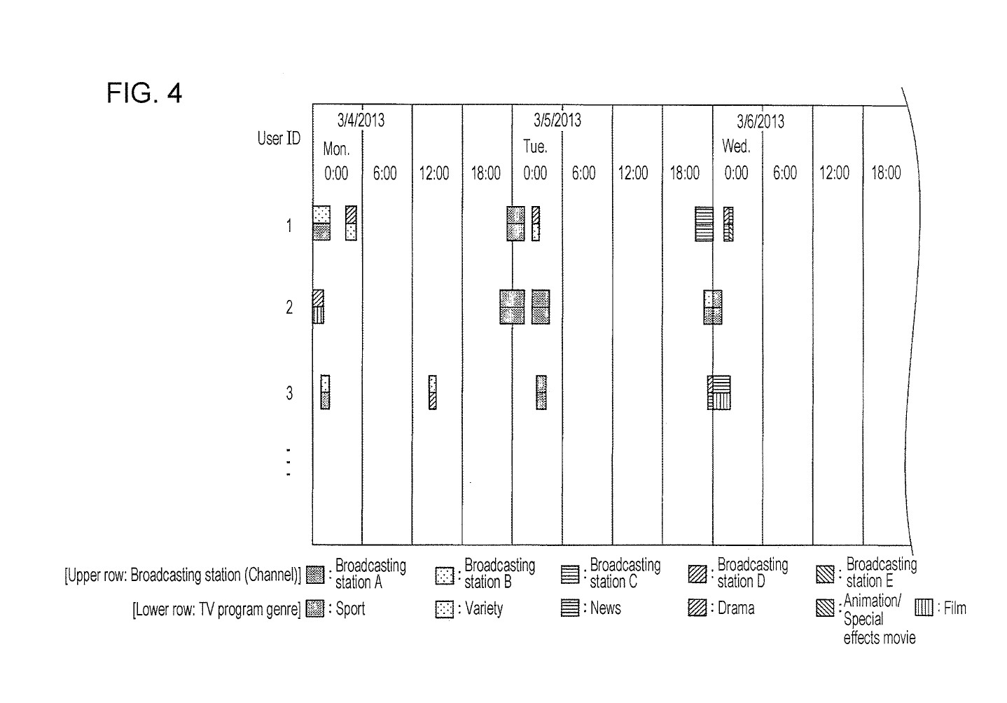

Now, a description of the television viewing history is given. An electronic device that is a television receiver accepts a user operation of turning on the power and further accepts a user operation of selecting a TV program. As a result, a broadcasting station is selected. The electronic device transmits a time period during which the user has watched the TV program to the database management system 200 over the network NW together with the broadcasting station selected by the user, the TV program name, and the genre of TV program. FIG. 4 is a diagram schematically illustrating the content of a television viewing history in the operation/activation history information 210 managed by the database management system 200. For example, the user having user ID 1 has viewed (or recorded) a sports show of broadcasting station B during a time period from 0:00 a.m. to 2:00 a.m. on Mar. 4, 2013.

The purchase/rental history information 220 managed by the database management system 200 is accumulated on the basis of information transmitted from the purchase/rental management device 300. The purchase/rental management device 300 transmits information about an item (including an electronic device and other items) purchased or rented by a user to the database management system 200 over the network NW.

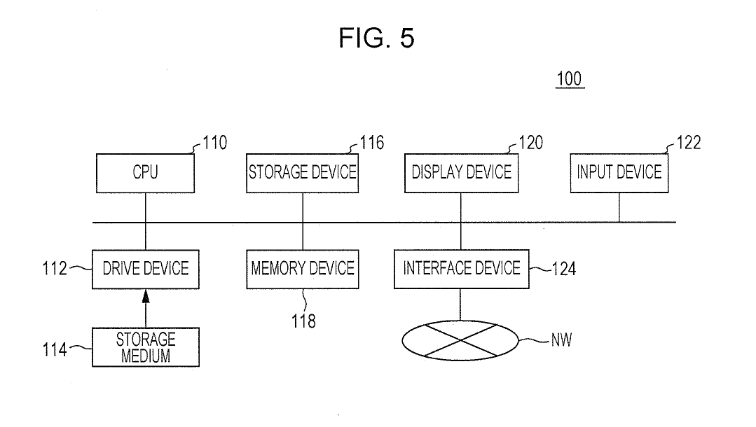

Now, a description of the information processing device 100 is given. FIG. 5 is a diagram illustrating an example of a hardware configuration of the information processing device 100. The information processing device 100 includes a CPU 110, a drive device 112, a storage device 116, a memory device 118, a display device 120, an input device 122, and an interface device 124, for example.

The CPU 110 executes various programs stored in the storage device 116 or the memory device 118. On the drive device 112, a storage medium 114, such as a USB memory, a CD (Compact Disc), a DVD (Digital Versatile Disc), or an SD card, is mounted. Examples of the storage device 116 include an HDD, a flash memory, a ROM (Read Only Memory), and the like.

Examples of the memory device 118 include a RAM (Random Access Memory), a register, and the like.

The display device 120 is a liquid crystal display device, an organic EL (Electroluminescence) display device, or the like. The input device 122 is a keyboard, a mouse, a touchpad, or other input devices. The interface device 124 includes a network card or the like for connection to the network NW.

Referring back to FIG. 1, a description is further given. The information processing device 100 includes an operation/activation history obtaining unit 130, a purchase/rental history obtaining unit 140, a classification processing unit 150, and an information generation unit 160 as functional units that operate when the CPU 110 executes a program stored in the storage device 116 or the memory device 118. The program may be a program that is stored in the storage medium 114 and installed on the storage device 116 or the like, or may be a program that is obtained from another computer over the network NW via the interface device 124. Note that some or all of the functional units may be implemented as a hardware functional unit, such as an IC (Integrated Circuit) or an LSI (Large Scale Integration).

The operation/activation history obtaining unit 130 obtains the operation/activation history information 210 from the database management system 200 and stores the operation/activation history information 210 in the memory device 118 or the storage device 116. The operation/activation history obtaining unit 130 is configured to include an operation history obtaining unit that stores an operation history included in the operation/activation history information 210 obtained from the database management system 200 in the memory device 118 or the storage device 116.

The purchase/rental history obtaining unit 140 obtains the purchase/rental history information 220 from the database management system 200 and stores the purchase/rental history information 220 in the memory device 118 or the storage device 116. Note that the operation/activation history obtaining unit 130 and the purchase/rental history obtaining unit 140 may be integrated into one functional unit to obtain the operation/activation history information 210 and the purchase/rental history information 220 together.

The classification processing unit 150 classifies users by their operation histories included in the operation/activation history information 210 obtained by the operation/activation history obtaining unit 130 into some groups of users having similar life patterns, users having similar operation histories being put in a group, to thereby classify the life patterns of the users. As a result of such a classification process, groups each constituted by users having life patterns similar to one another are formed, and information indicating the formed groups and users belonging to the respective groups is generated. The generated information is information indicating a classification result described below, that is, indicating one element of classified life patterns of users. Here, a life pattern (described in embodiments of the present invention) is information in which a time period during which it is inferred that a user is acting in his/her home and a time period other than the above-mentioned time period (a time period during which the user is outside his/her home or a time period during which the user is sleeping) are distinguished from each other and patterned. A life pattern is not limited to the above-described information and may be information in which a time period during which it is inferred that a user is outside his/her home is patterned, or information in which a time period during which it is inferred that a user is at home is patterned. The classification processing unit 150 generates a feature vector for each user (the above-described patterned information) on the basis of an operation history included in the operation/activation history information 210 (information obtained by excluding the measured amount of clothing related to a washing machine, activation times of a microwave oven, and the like from the operation/activation history information 210). The classification processing unit 150 stores the generated feature vector and the user ID of the user in association with each other in a storage area that is individually provided for each user in the memory device 118 or the storage device 116.

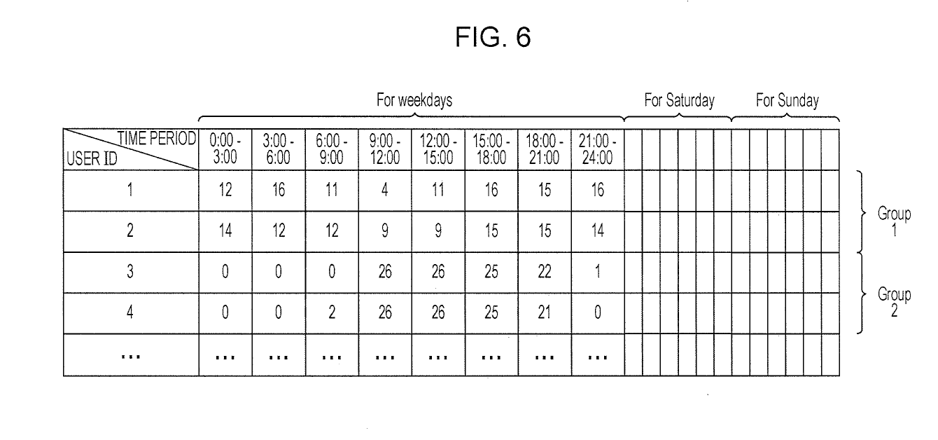

FIG. 6 is a diagram illustrating an example of the content of feature vectors generated by the classification processing unit 150. The feature vector is generated by counting the number of operations performed on any electronic device for each time period on weekdays, Saturday, and Sunday and normalizing the result of counting by a factor so that the sum of the values for weekdays, that for Saturday, and that for Sunday are each equal to 100. Alternatively, the feature vector may be generated by adding up television viewing times for each time period on weekdays, Saturday, and Sunday and normalizing the result of addition by a factor so that the sum of the values for weekdays, that for Saturday, and that for Sunday are each equal to 100, for example. Further, the feature vector may reflect both operations of any electronic device and television viewing times (for example, a viewing time of 30 minutes may be converted into one operation to thereby count the number of times).

The classification processing unit 150 groups users for which it is determined in a clustering process that the feature vectors are similar to one another into some types having similar life patterns. That is, the classification processing unit 150 forms groups each constituted by users respectively corresponding to feature vectors that are similar to one another, and generates information indicating the formed groups and users belonging to the respective groups. The generated information is information indicating a classification result described below, that is, indicating one element of classified life patterns of users. As a method for clustering, any method, such as hierarchical clustering, k-means, or self-organizing maps (SOM), can be used. In the example illustrated in FIG. 6, the classification processing unit 150 obtains a classification result that the user having user ID 1 (hereinafter “user 1”) and user 2 belong to group 1, and user 3 and user 4 belong to group 2. That is, in this example, the classified life patterns of users are information that includes formed groups, users belonging to the groups, and the feature vectors of the users belonging to the groups.

The information generation unit 160 generates information to be provided to a user on the basis of the life pattern of the user classified by the classification processing unit 150. In the first embodiment, the information generation unit 160 generates information to be provided to a user on the basis of information about preferences of the user and the classified life pattern of the user. That is, the information generation unit 160 uses information about preferences of each of a plurality of users and life patterns of users (described below) which are summarized for each group to which corresponding users belong, and generates information to be provided to the respective users. The generation of information is described below.

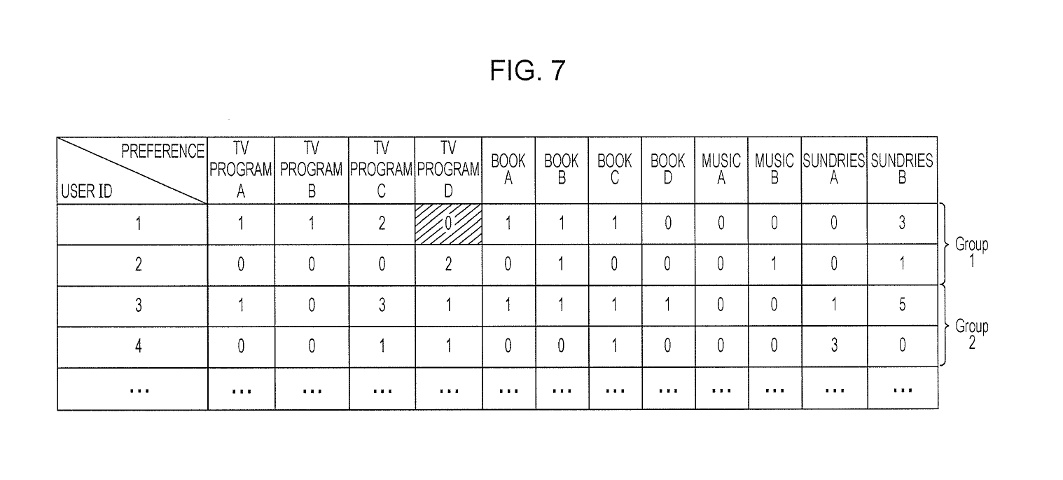

First, the information generation unit 160 patterns, for each user, information about preferences of the user. Information about preferences of a user is information about objects that the user views, purchases, or rents, for example, by preference and more specifically, corresponds to information about TV program names and the genres of TV programs in the television viewing history, the genres of items included in the purchase/rental history information 220, or the like. FIG. 7 is a diagram illustrating an example of patterned information about preferences of users. The information generation unit 160 may increment a corresponding data item by 1 each time an action, such as viewing, purchase, rental, or the like, is performed, or may increment a corresponding data item by 1 when any of the actions described above has been performed several times. A vector that includes, as element values, the values of respective data items obtained as a result of the above-described increment corresponds to information about preferences of the user. Note that the initial value of each data item is 0. The information generation unit 160 stores the user ID of each user and the values of respective data items for the user in association with each other in a storage area that is individually provided for each user in the memory device 118 or the storage device 116. The information generation unit 160 may change the rule of increment in accordance with the data label, such as “TV program” or “book”.

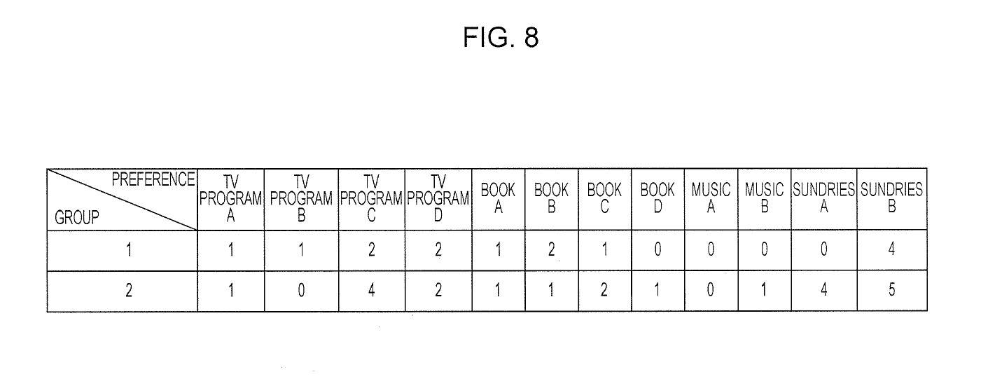

Next, the information generation unit 160 summarizes patterned information about preferences of users for each “group having similar life patterns” determined by the classification processing unit 150. As a method for summarizing information, various methods of (1) simply adding the values for users within the group, (2) averaging the values, and (3) aggregating only the values of items for which users having a value other than zero are a majority can be employed, for example. With the method (1), the sum of vectors each corresponding to information about preferences of each user in each group can be obtained. With the method (2), the average of vectors each corresponding to information about preferences of each user in each group can be obtained. With the method (3), a vector that includes the values of items that are aggregated (summed up, averaged, or the like) for each group as elements can be obtained. A vector obtained for each group by summarizing information corresponds to information that indicates the life patterns of users summarized for the group. The information generation unit 160 stores identification information of each group and the values of respective data items for the group in association with each other in a storage area that is individually provided for each group in the memory device 118 or the storage device 116. FIG. 8 is a diagram illustrating an example of information obtained by summarizing information about preferences of users having similar life patterns for each group. Information thus summarized can be information about preferences which is highly likely to be applicable in common to users belonging to the group.

When the information generation unit 160 obtains the summarized information, the information generation unit 160 generates, as information to be provided to each user, information obtained by excluding a duplicated portion of the summarized information and information about preferences of the user. In the examples illustrated in FIG. 7 and FIG. 8, although “2” is indicated for “TV program D” in the summarized data of group 1, zero is indicated for “TV program D” as a preference of user 1 belonging to group 1. That is, it is found that although users in group 1 watch TV program D by preference, user 1 that belongs to the same group 1 (that has a life pattern similar to those of the users in group 1) does not watch TV program D. Accordingly, it is inferred that user 1 is highly likely to become interested in TV program D.

Here, the information generation unit 160 refers to the information about preferences of users (see FIG. 7), and determines that the value of “TV program D” which corresponds to user ID “1” is “0” and is not equal to or larger than “1”. The information generation unit 160 also refers to the summarized information (see FIG. 8), and determines that the value of “TV program D” which corresponds to group 1 to which user 1 having user ID “1” belongs is “2” and is equal to or larger than “1”. On the basis of determination described above, the information generation unit 160 can determine that the data item of “TV program D” is not a duplicated portion of the summarized information and the information about preferences of the user.

Accordingly, the information generation unit 160 generates information about TV program D (advertisement information) for user 1 and transmits the information to the information provision device 400. Note that, in a case where both the value of a data item included in information about preferences of a user and the value of the data item included in the summarized information are equal to or larger than “1”, the information generation unit 160 can determine that the data item is a duplicated portion of the summarized information and the information about preferences of the user.

By performing the above-described process, the information processing device 100 can generate information about the genre of a TV program or an item that a user has not been aware of, that is, information for making a valuable suggestion to the user.

As the information provision device 400, various types of devices can be used in accordance with the type of information provided to a user. For example, the information provision device 400 may be a mobile phone or a tablet terminal owned by the user, a terminal device, such as a personal computer, a television receiver, or the like, or may be an information provision terminal installed in a sales store or a rental shop. In the latter case, when a user passes the card described with reference to FIG. 3 over a reader, the member number or the like of the card is read and transmitted to the information processing device 100. The information processing device 100 extracts a user ID corresponding to the member number or the like and transmits information generated by the information generation unit 160 on the basis of the user ID to the information provision device 400. The information provision device 400 displays the information received from the information processing device 100 on the screen of a display device so as to be visible to the user who has passed the card. As a result, the user can save time to find by himself/herself an item or the like that the user is planning to purchase or rent.

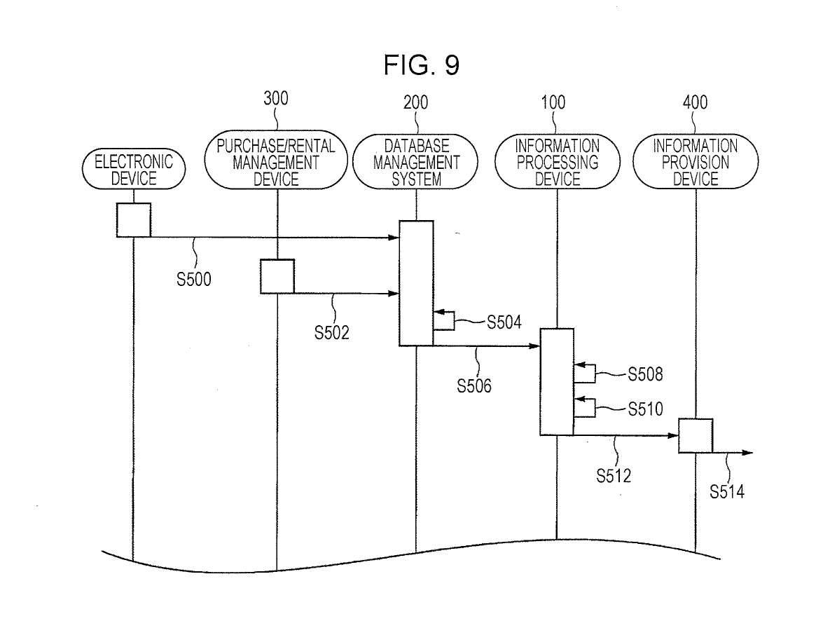

FIG. 9 illustrates an example of a sequence chart illustrating a flow of a process performed by the information processing system according to this embodiment. An electronic device that constitutes the information processing system transmits an operation history of operations performed by a user and other information to the database management system 200 (step S500). The purchase/rental management device 300 transmits information about an item purchased or rented by the user to the database management system 200 (step S502). The database management system 200 organizes the received information in association with the user ID (step S504) and transmits the information to the information processing device 100 (step S506).

The information processing device 100 classifies the life pattern of the user on the basis of the received information (step S508) and generates information to be provided to the user on the basis of the classified life pattern of the user and information about preferences of the user (step S510). The information processing device 100 transmits the generated information to the information provision device 400 (step S512), and the information provision device 400 provides the received information to the user (step S514).

With the information processing device 100 according to the first embodiment described above, the life pattern of a user is classified on the basis of information obtained from an electronic device via the database management system 200, and information to be provided to the user is generated on the basis of the classified life pattern of the user and information about preferences of the user. Accordingly, it is possible to generate information for making a valuable suggestion to the user.

### Second Embodiment

The information processing device 100 according to a second embodiment of the present invention and an information provision method related thereto will be described below. In the information processing device 100 according to the second embodiment, a process performed by the information generation unit 160 is different from that in the first embodiment, and processes performed by other functional units are the same as those in the first embodiment. Therefore, only a process performed by the information generation unit 160 will be described hereinafter.

The information generation unit 160 according to the second embodiment generates, as information to be provided to a user, information about a duplicated portion of patterned information about preferences of the user (see FIG. 7) and information obtained by summarizing information about preferences of users having similar life patterns for each group (see FIG. 8). In the examples illustrated in FIG. 7 and FIG. 8, the information generation unit 160 generates information about “TV programs A to C”, “books A to C” and “sundries B” as information to be provided to user 1 and transmits the information to the information provision device 400. Here, information about “books A to C” and “sundries B” need not be information about books and sundries themselves that the user has actually purchased or rented, and may be information about books and sundries that belong to the categories corresponding to “books A to C” and “sundries B” and that have not been actually purchased or rented by the user.

In doing so, the information generation unit 160 can generate information about a duplicated portion of preferences of a user and preferences of a group having life patterns similar to that of the user, that is, information about preferences, the information being highly likely to be needed by the user, among preferences of the user. As a result, the information generation unit 160 can generate information for making a valuable suggestion to the user.

With the information processing device 100 according to the second embodiment described above, the life pattern of a user is classified on the basis of information obtained from an electronic device via the database management system 200, and information to be provided to the user is generated on the basis of the classified life pattern of the user and information about preferences of the user. Accordingly, it is possible to generate information for making a valuable suggestion to the user.

### Third Embodiment

The information processing device 100 according to a third embodiment of the present invention and an information provision method related thereto will be described below. In the information processing device 100 according to the third embodiment, a process performed by the information generation unit 160 is different from that in the first embodiment, and processes performed by other functional units are the same as those in the first embodiment. Therefore, only a process performed by the information generation unit 160 will be described hereinafter.

The information generation unit 160 according to the third embodiment generates, as information to be provided to a user, information that includes both patterned information about preferences of the user (see FIG. 7) and information obtained by summarizing information about preferences of users having similar life patterns for each group (see FIG. 8). In the examples illustrated in FIG. 7 and FIG. 8, the information generation unit 160 generates information about “TV programs A to D”, “books A to C” and “sundries B” as information to be provided to user 1 and transmits the information to the information provision device 400. In doing so, the information generation unit 160 can generate information that covers both preferences of a user and preferences of a group having life patterns similar to that of the user. As a result, the information generation unit 160 can generate information for making a valuable suggestion to the user.

With the information processing device 100 according to the third embodiment described above, the life pattern of a user is classified on the basis of information obtained from an electronic device via the database management system 200, and information to be provided to the user is generated on the basis of the classified life pattern of the user and information about preferences of the user. Accordingly, it is possible to generate information for making a valuable suggestion to the user.

### Fourth Embodiment

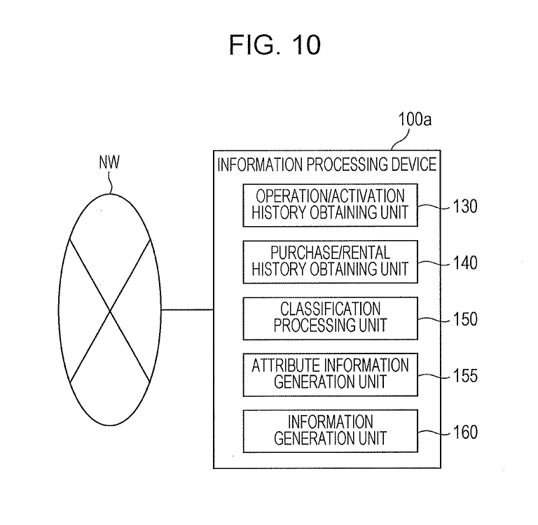

An information processing device 100a according to a fourth embodiment of the present invention and an information provision method related thereto will be described below. FIG. 10 is a diagram illustrating an example of a functional configuration of the information processing device 100a according to the fourth embodiment. The information processing device 100a according to the fourth embodiment includes an attribute information generation unit 155 in addition to the constituent elements included in the information processing device 100 according to the first to third embodiments. Note that, for other devices connected to the network NW, which are not illustrated, see FIG. 1.

The attribute information generation unit 155 generates attribute information about a user on the basis of the operation/activation history information 210 and the purchase/rental history information 220. Attribute information about a user is information including the family structure (single, married couple, two-family, elderly, child-raising, and so on), sex, age group, and the like of the user. Attribute information about a user may be information that incorporates information about preferences of the user (for example, “single who loves to cook”, “sports-loving single”, “film-loving elderly person”, or “elderly person who loves to read”).

Attribute information can be derived on the basis of a viewing history related to television programs (childcare programs, home shopping programs, and the like) targeting a specific family structure or age group and a purchase history related to items (disposable diapers, for example) and also on the basis of the operation/activation history information 210. For example, a time of day during which a user is at home can be determined from a time when an electronic device is operated, and the family structure of a user can be determined approximately from the amount of clothing to be washed or the frequency of washing related to a washing machine, the frequency of activation of a microwave oven, and the like. For example, it is assumed that a single operates a washing machine mainly in the early morning and at night and that a family with children has a larger amount of clothing to be washed in the evening and so on than a family with no children. The attribute information generation unit 155 can combine the pieces of information described above to thereby appropriately generate attribute information about the user.

In the memory device 118 or the storage device 116, attribute information indicating attributes of a user is stored in advance in association with an attribute vector that includes, as element values, certain combinations of the number of times the user watches certain television programs related to the attributes, the number of times the user operates certain devices related to the attributes or the operation time of certain devices related to the attributes for each time period, and the frequency of purchasing and the frequency of renting certain items related to the attributes.

The attribute information generation unit 155 calculates, as element values, the number of times the user watches certain television programs and the number of times the user operates certain devices or the operation time of certain devices for each time period from the operation/activation history information 210. The attribute information generation unit 155 may calculate, as element values, the frequency of purchasing and the frequency of renting certain items from the purchase/rental history information 220. The attribute information generation unit 155 generates a vector composed of the calculated element values. The attribute information generation unit 155 calculates an index value that indicates to what degree the generated vector is analogous to each attribute vector stored in the memory device 118 or the storage device 116. The attribute information generation unit 155 identifies an attribute vector for which the calculated index value indicates the highest analogous degree. The attribute information generation unit 155 determines attribute information that corresponds to the identified attribute vector to be attribute information about the user.

The information generation unit 160 according to the fourth embodiment generates information to be provided to the user on the basis of the life pattern of the user classified by the classification processing unit 150, information about preferences of the user, and attribute information about the user, for example. The information generation unit 160 selects preferences that match attributes of user 1 from among preferences (“TV programs A to D”, “books A to C” and “sundries B” in the examples illustrated in FIG. 7 and FIG. 8) corresponding to group 1 to which user 1 belongs, for example, and generates information to be provided to user 1. For example, in a case where attribute information about user 1 indicates “single”, the information generation unit 160 extracts, from a database (not illustrated), items or the like in a size and a price range for singles from among items or the like that belong to sundries B, and generates information to be provided to user 1. In a case where attribute information about a user indicates “elderly”, a “film popular among elderly people” or the like may be generated as information to be provided to the user. In a case where attribute information about a user indicates “single (business person)”, a “must-read for business people” or the like may be generated as information to be provided to the user.

The above-described database is built in the storage device 116, for example, and stores therein attribute information and program information or item information in association with each other. The database also stores therein item information indicating each item and detail information indicating the details of the item (size and price, for example) in association with each other. The information generation unit 160 refers to the database, identifies item information that corresponds to attributes of the user, reads item information that corresponds to the identified item information, and generates information that includes the read item information as information to be provided to the user.

Note that the information generation unit 160 according to the fourth embodiment may generate information to be provided to a user at least on the basis of attribute information about the user, and may generate information to be provided to a user without referring to other elements (information about the life pattern of the user and preferences of the user). In this case, the information generation unit 160 may include various types of content and items that are “popular among elderly people” in information to be provided to a user if attribute information about the user indicates “elderly”.

By performing the process described above, the information processing device 100a can generate information that corresponds to the life pattern of a user and attribute information about the user (family structure, sex, age group, and the like) and provide the information to the user. As a result, it is possible to generate information for making a valuable suggestion to the user.

With the information processing device 100a according to the fourth embodiment described above, the life pattern of a user is classified on the basis of information obtained from an electronic device via the database management system 200, attribute information about the user is generated on the basis of the classified life pattern of the user, and information to be provided to the user is generated on the basis of the attribute information. Accordingly, it is possible to generate information for making a valuable suggestion to the user.

Note that, in the fourth embodiment, linking with the card as described with reference to FIG. 3 is not essential. Here, information about preferences of a user may be excluded from a process of generating information to be provided to the user, and the information generation unit 160 may generate information to be provided to the user on the basis of the life pattern of the user and attribute information about the user. For example, in a case where attribute information about a user indicates “single”, the information generation unit 160 extracts a wide range of items or the like in a size and a price range for singles from the database (not illustrated), and generates information to be provided to the user. Further, the information generation unit 160 may generate information about preferences of a user within a scope obtainable from an electronic device and may reflect the information in information to be provided to the user.

Further, in the fourth embodiment, in a case where the attribute information generation unit 155 is unable to generate attribute information because there is limited information about a user, attribute information may be associated with a group based on a life pattern. For example, in the example illustrated in FIG. 7, attribute information indicating that users belonging to group 1 are singles and attribute information indicating that users belonging to group 2 are full-time housewives, for example, may be associated with the respective groups. In a case where it is not possible to generate attribute information about a specific user, attribute information that is associated with a group to which the user belongs may be assumed to be attribute information about the user. Alternatively, attribute information need not be generated for individual users, and attribute information that is associated with a group may be applied to all users in the group.

### <Modifications>

Although forms for implementing the present invention have been described with reference to embodiments, the present invention is not limited to the embodiments, and various modifications and replacement can be made without departing from the spirit of the present invention.

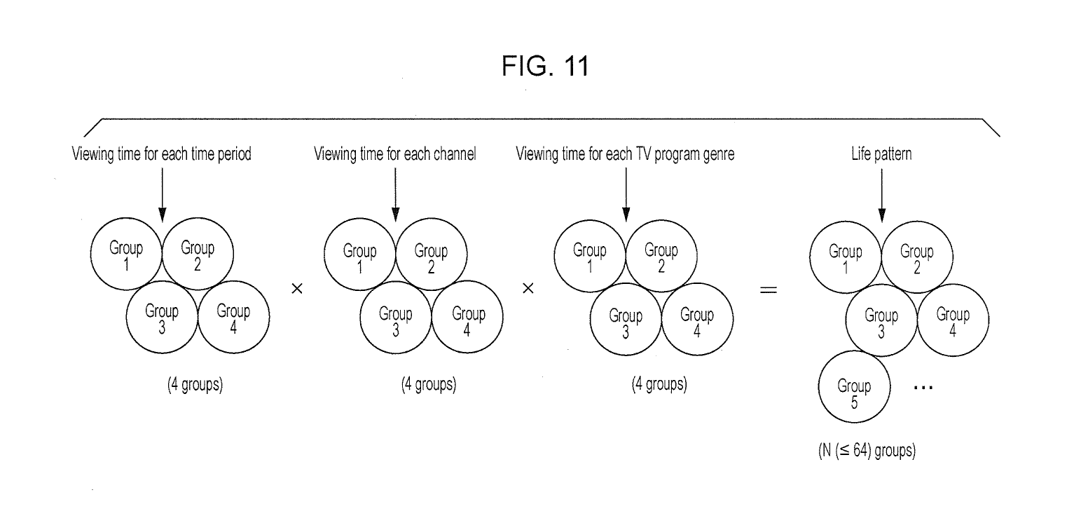

For example, the classification processing unit 150 in the above-described embodiments may perform a combination of a plurality of clustering processes. FIG. 11 is a diagram schematically illustrating a state where the classification processing unit 150 performs a plurality of clustering processes on the basis of a television viewing history. The classification processing unit 150 may combine a clustering process (the same as that in the embodiments) that assumes a viewing time for each time period to be a feature vector, a clustering process that assumes a viewing time for each channel to be a feature vector, and a clustering process that assumes a viewing time for each TV program genre to be a feature vector with one another, and may put users in groups corresponding to a larger number of life patterns in accordance with the combination.

Further, although the classification processing unit 150 according to the above-described embodiments is configured to put a plurality of users in a group on the basis of the life patterns of the users to thereby classify the life patterns of the users, the life patterns of users may be classified by categorizing each of the life patterns of the users into any of the absolute types, such as “early-riser type” and “night person type”, prepared in advance.

The present invention can be implemented in the following forms. Note that reference numerals indicated below are merely examples, and the present invention is not limited to these.

### (Supplementary Note 1)

An information processing device (100, 100a) including: an operation history obtaining unit that obtains an operation history (210) of an electronic device (1-1, 1-2, 1-m, 2-1, 2-2, 2-k, n-1) installable in a home; and a classification unit that classifies a life pattern of a user operating the electronic device on the basis of the operation history obtained by the operation history obtaining unit.

### (Supplementary Note 2)

The information processing device according to Supplementary Note 1, in which the classification unit classifies the life pattern of the user operating the electronic device by putting users for which operation histories obtained by the operation history obtaining unit are similar to one another in a group as users having similar life patterns.

### (Supplementary Note 3)

The information processing device according to Supplementary Note 1 or 2, further including: an information generation unit (160) that generates information to be provided to a user on the basis of the life pattern of the user classified by the classification unit.

### (Supplementary Note 4)

The information processing device according to Supplementary Note 3, further including: a preference information obtaining unit (130, 140) that obtains information about preferences of a user, in which the information generation unit generates the information to be provided to a user on the basis of the life pattern of the user classified by the classification unit and the information about preferences of the user obtained by the preference information obtaining unit.

### (Supplementary Note 5)

The information processing device according to Supplementary Note 4, in which the information generation unit generates information obtained by excluding a duplicated portion of information obtained by summarizing information about preferences of users in a group to which the user belongs and the information about preferences of the user, as the information to be provided to the user.

### (Supplementary Note 6)

The information processing device according to Supplementary Note 4, in which the information generation unit generates information about a duplicated portion of information obtained by summarizing information about preferences of users in a group to which the user belongs and the information about preferences of the user, as the information to be provided to the user.

### (Supplementary Note 7)

The information processing device according to Supplementary Note 4, in which the information generation unit generates information that includes both information obtained by summarizing information about preferences of users in a group to which the user belongs and the information about preferences of the user, as the information to be provided to the user.

### (Supplementary Note 8)

The information processing device according to any one of Supplementary Notes 3 to 7, further including: an attribute information generation unit that generates attribute information about a user on the basis of information including the life pattern of the user classified by the classification unit, in which the information generation unit generates the information to be provided to the user on the basis of the attribute information generated by the attribute information generation unit.

### (Supplementary Note 9)

An information provision method including: transmitting, by an electronic device that is installable in a home and that is associated with a specific user, an operation history of the electronic device; classifying a life pattern of the user on the basis of the operation history received from the electronic device by putting users for which operation histories are similar to one another in a group as users having similar life patterns, generating information to be provided to the user on the basis of the classified life pattern of the user, and transmitting the information to an information provision device by an information processing device; and providing, by the information provision device, the information received from the information processing device to the user.

### INDUSTRIAL APPLICABILITY

As described above, the information processing device, the information processing method, the information processing system, the information provision device, and the programs thereof in the present invention are useful in providing information for making suggestions valuable to users.

### REFERENCE SIGNS LIST

100, 100a . . . information processing device

110 . . . CPU

130 . . . operation/activation history obtaining unit

140 . . . purchase/rental history obtaining unit

150 . . . classification processing unit

155 . . . attribute information generation unit

160 . . . information generation unit

200 . . . database management system

300 . . . sales/rental management device

400 . . . information provision device

NW . . . network

1. An information processing device comprising:
an operation history obtaining unit that obtains an operation history of an electronic device installable in a home; and
a classification unit that classifies a life pattern of a user operating the electronic device on the basis of the operation history obtained by the operation history obtaining unit.

2. The information processing device according to claim 1, wherein
the classification unit classifies the life pattern of the user operating the electronic device by putting users for which operation histories obtained by the operation history obtaining unit are similar to one another in a group as users having similar life patterns.

3. The information processing device according to claim 1, further comprising:
an information generation unit that generates information to be provided to a user on the basis of the life pattern of the user classified by the classification unit.

4. The information processing device according to claim 3, further comprising:
a preference information obtaining unit that obtains information about preferences of a user, wherein
the information generation unit generates the information to be provided to a user on the basis of the life pattern of the user classified by the classification unit and the information about preferences of the user obtained by the preference information obtaining unit.

5. The information processing device according to claim 4, wherein
the information generation unit generates information obtained by excluding a duplicated portion of information obtained by summarizing information about preferences of users in a group to which the user belongs and the information about preferences of the user, as the information to be provided to the user.

6. The information processing device according to claim 3, further comprising:
an attribute information generation unit that generates attribute information about a user on the basis of information including the life pattern of the user classified by the classification unit, wherein
the information generation unit generates the information to be provided to the user on the basis of the attribute information generated by the attribute information generation unit.

7. An information provision method comprising:
transmitting, by an electronic device that is installable in a home and that is associated with a specific user, an operation history of the electronic device;
classifying a life pattern of the user on the basis of the operation history received from the electronic device by putting users for which operation histories are similar to one another in a group as users having similar life patterns, generating information to be provided to the user on the basis of the classified life pattern of the user, and transmitting the information to an information provision device by an information processing device; and
providing, by the information provision device, the information received from the information processing device to the user.

8. An information processing system comprising:
an information processing device; and an information provision device, wherein
the information processing device includes
an operation history obtaining unit that obtains an operation history of an electronic device installable in a home,
a classification unit that classifies a life pattern of a user operating the electronic device on the basis of the operation history obtained by the operation history obtaining unit, and
an information generation unit that generates information to be provided to the user on the basis of the life pattern of the user classified by the classification unit and transmits the information to the information provision device.

9. An information provision device comprising:
a reception unit that receives, from an information processing device, information generated on the basis of a life pattern of a user, the life pattern being classified on the basis of an operation history of an electronic device; and
a display unit that displays the information received by the reception unit to a user of the electronic device.

10. A program product for providing information, the program product including a program capable of executing steps comprising:
a reception step of receiving, from an information processing device, information generated on the basis of a life pattern of a user, the life pattern being classified on the basis of an operation history of an electronic device; and
a display step of displaying the information received in the reception step to a user of the electronic device.

11. The information processing device according to claim 2, further comprising:
an information generation unit that generates information to be provided to a user on the basis of the life pattern of the user classified by the classification unit.

12. The information processing device according to claim 4, further comprising:
an attribute information generation unit that generates attribute information about a user on the basis of information including the life pattern of the user classified by the classification unit, wherein
the information generation unit generates the information to be provided to the user on the basis of the attribute information generated by the attribute information generation unit.

13. The information processing device according to claim 5, further comprising:
an attribute information generation unit that generates attribute information about a user on the basis of information including the life pattern of the user classified by the classification unit, wherein
the information generation unit generates the information to be provided to the user on the basis of the attribute information generated by the attribute information generation unit.
